(19) United States
(12) Patent Application Publication
(10) Pub. No.: US 2014/0292838 A1
(43) Pub. Date: Oct. 2, 2014

(54) ORGANIC LIGHT EMITTING DISPLAY DEVICE AND DRIVING METHOD THEREOF

(71) Applicant: SAMSUNG DISPLAY CO., LTD., Yongin-City (KR)

(72) Inventor: Young-Uk WON, Yongin-City (KR)

(73) Assignee: SAMSUNG DISPLAY CO., LTD., Yongin-City (KR)

(21) Appl. No.: 14/228,320

(22) Filed: Mar. 28, 2014

(30) Foreign Application Priority Data
Apr. 1, 2013 (KR) 10-2013-0035287

(51) Int. Cl. G09G 3/20; G09G 3/32

(52) U.S. Cl. CPC G09G 3/2007; G09G 3/3225
USPC 345/691; 345/77

(57) ABSTRACT

An organic light emitting display and a driving method thereof are provided. The organic light emitting display includes a display region including a plurality of data lines, a plurality of scan lines, and a plurality of pixels connected to corresponding data lines and corresponding scan lines, a signal controller that converts input data into grayscale data according to gamma control data in a normal mode, changes the gamma control data according to dimming data in a dimming mode to generate gamma correction data, and converts the grayscale data into correction data according to the gamma correction data, a scan driver that supplies a plurality of scan signals to the plurality of scan lines, and a data driver that generates a plurality of data signals corresponding to the grayscale data or the correction data, and supplies the plurality of data signals to the plurality of data lines.

### CROSS-REFERENCE TO RELATED APPLICATION

The present application claims priority under 35 U.S.C. §119 to Korean Patent Application No. 10-2013-0035287, filed on Apr. 1, 2013, in the Korean Intellectual Property Office, and entitled: “Organic Light Emitting Display Device and Driving Method Thereof,” which is incorporated by reference herein in its entirety.

### BACKGROUND

1. Field

Embodiments relate to an organic light emitting display device and a driving method thereof.

2. Description of the Related Art

Display devices are used as screens for handheld terminals, e.g., personal computers, mobile phones, and PDAs, or as monitors for various types of information devices. Display devices include a liquid crystal display device (LCD) using an LCD panel, an organic light emitting display device using an organic light emitting element, a plasma display panel (PDP) using a plasma panel, and the like. Particularly, organic light emitting display devices, which have high light-emitting efficiency and luminance, wide viewing angle and fast response speed, have been favored.

In general, an organic light emitting display device starts to display an image on the display panel after performing a hardware reset process and an initialization process in response to a user operation. If there is no user operation for a predetermined amount of time, the driving voltage applied to the display panel is cut off to switch the display to power saving mode or standby mode.

The initialization process involves setting an initialization value, i.e., luminance, for driving the display panel, or setting the voltage level of a scan signal or a light-emission control signal, or recording register information or the like for gamma setting in a register within a driver IC.

The above information disclosed in this Background section is only for enhancement of understanding of the background of the invention and therefore it may contain information that does not form the prior art that is already known in this country to a person of ordinary skill in the art.

### SUMMARY

One or more embodiments is directed to providing an organic light emitting display including: a display region including a plurality of data lines, a plurality of scan lines, and a plurality of pixels connected to the corresponding data lines and the corresponding scan lines; a signal controller that converts input data into grayscale data according to gamma control data in normal mode, changes the gamma control data according to dimming data in dimming mode to generate gamma correction data, and converts the grayscale data into correction data according to the gamma correction data; a scan driver that supplies a plurality of scan signals to the plurality of scan lines; and a data driver that generates a plurality of data signals corresponding to the grayscale data or the correction data, and supplies the plurality of data signals to the plurality of data lines.

The dimming data may include a preset number of dimming stages and the dimming time for each of the dimming stages. The organic light emitting display may further include a register unit that generates a display-on signal, which is enabled when display-on time for the display of an image on the display region is recorded, and a display-off signal, which is enabled when display-off time for the non-display of an image on the display region is recorded.

The signal controller may include: a frame counter that counts a sequence of frames of the input data, in synchronization with the display-on signal or the display-off signal; a luminance change rate calculator that matches each frame sequence to a corresponding dimming stage according to the dimming data, and calculates the luminance change rate for each frame sequence corresponding to each dimming stage; and a gamma setting unit that generates the gamma correction data according to the luminance change rate.

The luminance change rate calculator may calculate the number of frames included in each of the plurality of dimming stages according to one period of a vertical synchronization signal for dividing the input data into a plurality of frames and the dimming time.

The dimming time may be equal for each of the dimming stages.

Correction data for the dimming stages may have different grayscales.

One or more embodiments is directed to providing a driving method of an organic light emitting display including a display region having a plurality of data lines, a plurality of scan lines, and a plurality of pixels connected to corresponding data lines and corresponding scan lines, the data lines receiving data signals and the scan lines receiving scan signals, the method including converting input data into grayscale data according to gamma control data in a normal mode, in a dimming mode, changing the gamma control data according to dimming data to generate gamma correction data and converting the grayscale data into correction data according to the gamma correction data and generating data signals corresponding to the grayscale data or the correction data.

The method may further include receiving the dimming data including a preset number of dimming stages and the dimming time for each of the dimming stages.

The method may further include: generating a display-on signal, which is enabled when display-on time for the display of an image on the display region is recorded; and generating a display-off signal, which is enabled when display-off time for the non-display of an image on the display region is recorded.

Generating the gamma correction data may include: counting a sequence of frames of the input data, in synchronization with the display-on signal or the display-off signal; matching each frame sequence to a corresponding dimming stage according to the dimming data; calculating the luminance change rate for each frame sequence corresponding to each dimming stage; and changing the gamma correction data according to the luminance change rate.

Matching each frame sequence to a corresponding step may include calculating the number of frames included in each of the plurality of dimming stages according to one period of a vertical synchronization signal for dividing the input data into a plurality of frames and the dimming time.

The dimming time may be equal for each of the dimming stages.

Correction data for the dimming stages may have different grayscales.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram showing an organic light emitting display in accordance with a first exemplary embodiment.

FIG. 2 illustrates an equivalent diagram of a pixel PX shown in FIG. 1.

FIG. 3 illustrates a detailed block diagram of the dimming controller of FIG. 1.

FIG. 4 illustrates a view to explain dimming stages in accordance with an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In describing example embodiment, parts that are not related to the description will be omitted. Like reference numerals generally designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

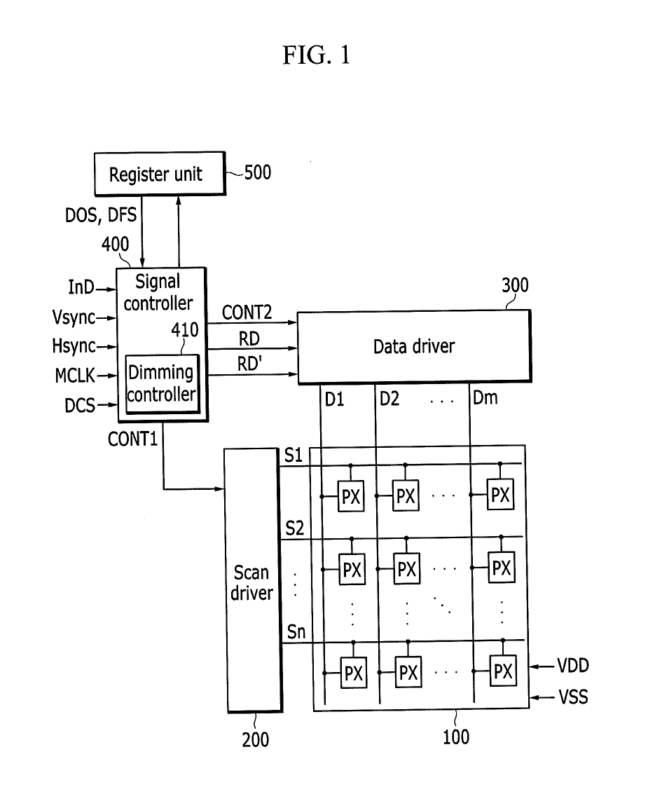

FIG. 1 illustrates a block diagram showing an organic light emitting display in accordance with a first exemplary embodiment. Referring to FIG. 1, an organic light emitting display according to an exemplary embodiment includes a display region 100, a scan driver 200, a data driver 300, and a timing controller 400.

The display region 100 includes a plurality of pixels PX, a plurality of scan lines for transmitting a plurality of scan signals Si to Sn, a plurality of data lines for transmitting a plurality of data signals D1 to Dm, and a plurality of lines for applying a first driving voltage VDD and a second driving voltage VSS.

Each of the plurality of pixels PX is connected to a corresponding scan line, a corresponding data line, the first driving voltage (VDD) supply line, and the second driving voltage (VSS) supply line. Each of the plurality of pixels PX may include a red subpixel emitting red light, a green subpixel emitting green light, and a blue subpixel emitting blue light, and displays images of various colors.

The scan driver 200 generates a plurality of scan lines S1 to Sn in response to a first driving control signal CONT1, and transfers them to the corresponding scan lines.

The data driver 300 receives a second driving control signal CONT2, grayscale data RD, and correction data RD′, generates a plurality of data signals D1 to Dm, and transfers them to the corresponding data lines. In a normal mode, the data driver 300 samples and latches grayscale data Rd in response to the second driving control signal CONT2 to generate a plurality of data signals D1 to Dm. In a dimming mode, the data driver 300 samples and latches correction data RD′ in response to the second driving control signal CONT2 to generate a plurality of data signals D1 to Dm.

The signal controller 400 externally receives input data InD and a synchronization signal for controlling the display of the input data InD. The synchronization signal includes a horizontal synchronization signal Hsync, a vertical synchronization signal Vsync, and a main clock signal MCLK. The signal controller 400 divides and aligns the input data InD into frames in response to the vertical synchronization signal Vsync, and divides and aligns input data InD for one frame by scan lines.

In the normal mode, the signal controller 400 generates gamma control data GCD according to pre-stored gamma curve information and converts the aligned input data InD into grayscale data RD according to the gamma control data GCD. Also, the signal controller 400 generates first and second driving control signals CONT1 and CONT2.

The signal controller 400 includes a dimming controller 410 that changes the gamma control data GCD according to dimming data DCS and generates gamma correction data GCD′. The dimming data DCS may include a preset number of dimming stages and a dimming time for each dimming stage.

In the dimming mode, the signal controller 400 converts the aligned input data InD into grayscale correction data RD′ according to the gamma correction data GCD′, in synchronization with a display-on signal DOS or display-off signal DFS. To this end, in initialization mode, the signal controller 400 records display-on time for starting the display of an image on the display region 100 in a register unit 500, and receives the display-on signal DOS from the register unit 500.

In a power saving mode or a standby mode, the signal controller 400 records display-off time for starting displaying of an image on the display region 100 in the register unit 500, and receives the display-off signal DFS from the register unit 500. The dimming mode according to an exemplary embodiment may be defined as a mode used when the display-on signal DOS or display-off signal DFS is recorded in the register unit 500. Embodiments are not limited thereto, e.g., the dimming mode may be used for an image displayed after or before a black image is displayed on the display region 100.

In an initialization mode, the register unit 500 generates the display-on signal DOS when the display-on time is recorded. In the power saving mode or the standby mode, the register unit 500 generates the display-off signal DFS when the display-off time is recorded.

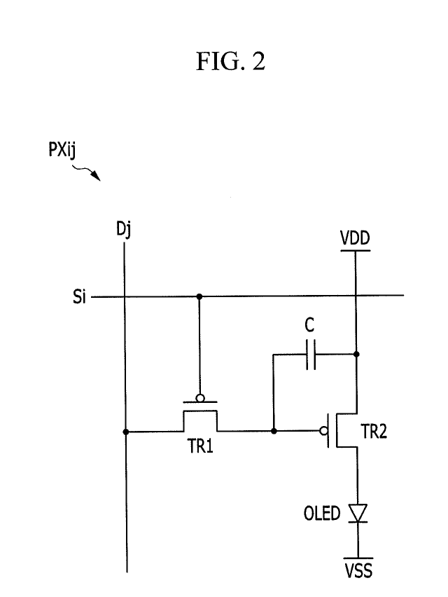

FIG. 2 illustrates an equivalent diagram of a pixel PX shown in FIG. 1. Referring to FIG. 2, among the plurality of pixels PX, a subpixel PXij connected to the i-th scan line Si and the j-th data line Dj is illustrated. The subpixel PXij includes a switching transistor TR1, a driving transistor TR2, a capacitor C, and an organic light emitting diode OLED.

The switching transistor TR1 includes a gate electrode connected to the scan line Si, a source electrode connected to the data line Dj, and a drain electrode connected to the gate electrode of the driving transistor TR2.

The driving transistor TR2 includes a source electrode connected to the first driving voltage (VDD) supply line, a drain electrode connected to the anode of the red organic light emitting diode OLED, and a gate electrode to which a data signal Vdata is transferred through the data line Dj during the turn-on period of the switching transistor TR1.

The capacitor C is connected between the gate electrode and source electrode of the driving transistor TR2. The cathode of the organic light emitting diode is connected to the second driving voltage (VSS) supply line.

When the switching transistor TR1 of a pixel PX having the above-described configuration is turned on by a scan signal Si, a data signal Vdata is transferred to the gate electrode of the driving transistor TR2. A voltage difference between the gate and source electrodes of the driving transistor TR2 is maintained by the capacitor C, and a driving current ld flows through the driving transistor TR2. The organic light emitting diode OLED emits light depending on the driving current Id.

The Pixel PX of FIG. 2 is merely an example of a pixel of a display device and other types of pixels can be used.

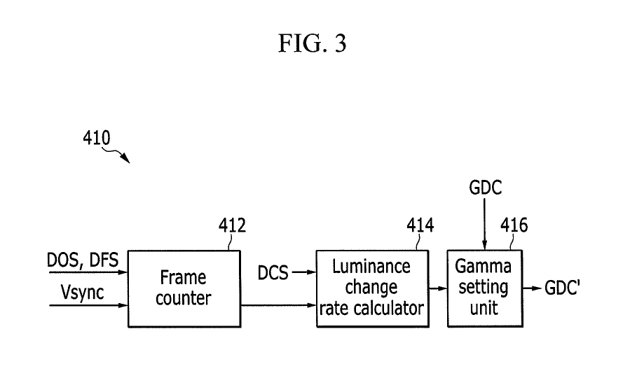

FIG. 3 illustrates a detailed block diagram of the dimming controller 410 of FIG. 1. Referring to FIG. 3, the dimming controller 410 according to the exemplary embodiment may include a frame counter 412, a luminance change rate calculator 414, and a gamma setting unit 416.

The frame counter 412 counts a sequence of frames of input data InD, in synchronization with the timing when a display-on signal DOS or display-off signal DFS is generated. The frame counter 412 may count a sequence of frames in response to a vertical synchronization signal Vsync.

The luminance change rate calculator 414 matches each frame sequence to a corresponding dimming stage, and calculates the luminance change rate for each of a plurality of dimming stages according to dimming data DCS. Specifically, the luminance change rate calculator 414 may match each frame sequence count to a corresponding dimming stage according to a number of dimming stages and a dimming time for each dimming stage.

Then, the luminance change rate calculator 414 may calculate the luminance change rate for each frame sequence corresponding to each dimming stage. The luminance change rate calculator 414 may use a plurality of dimming stages for low grayscale input data InD and a single dimming stage for high grayscale input data InD.

The gamma setting unit 416 changes the gamma control data GDC according to the calculated luminance change rate and generates gamma correction data GDC′.

An operation of the dimming controller 410 having the above-described configuration will now be described in detail. The following description will be made of the case where the number of dimming stages is set to 4, and the dimming time for each dimming stage is set to 0.5 seconds. In this case, the driving frequency of the organic light emitting display 1 is 60 Hz, and one period of the vertical synchronization signal Vsync is 1/60 seconds.

First, the frame counter 412 counts the number of frames of input data InD, in synchronization with a display-on signal DOS or display-off signal DFS.

Then, the luminance change rate calculator 414 calculates the number of frames included in each stage by using one period of the vertical synchronization signal Vsync and the dimming time for each stage. That is, since one period of the vertical synchronization signal Vsync is 1/60 seconds, and a single stage lasts for 0.5 seconds, three frames are included in each stage.

As such, the luminance change rate calculator 414 matches first to third input frames to a first dimming stage and fourth to sixth input frames to a second dimming stage. Subsequently, the luminance change rate calculator 414 matches seventh to ninth input frames to a third dimming stage and tenth to twelfth input frames to a fourth dimming stage.

Next, the luminance change rate calculator 414 calculates the luminance change rate of each frame sequence according to the corresponding dimming stage. For example, the luminance change rate of the first dimming stage is 25%, the luminance change rate of the second dimming stage is 50%, the luminance change rate of the third dimming stage is 75%, and the luminance change rate of the fourth dimming stage is 100%.

Next, the gamma setting unit 416 generates gamma correction data GDC′ for converting grayscale data RD of a given frame into correction data RD′ according to the luminance change ratio calculated for each dimming stage. For example, grayscale data RD representing twenty grayscales may be converted into correction data RD′ representing five grayscales in the first dimming stage, correction data RD′ representing ten grayscales in the second dimming stage, or correction data RD′ representing fifteen grayscales in the third dimming stage.

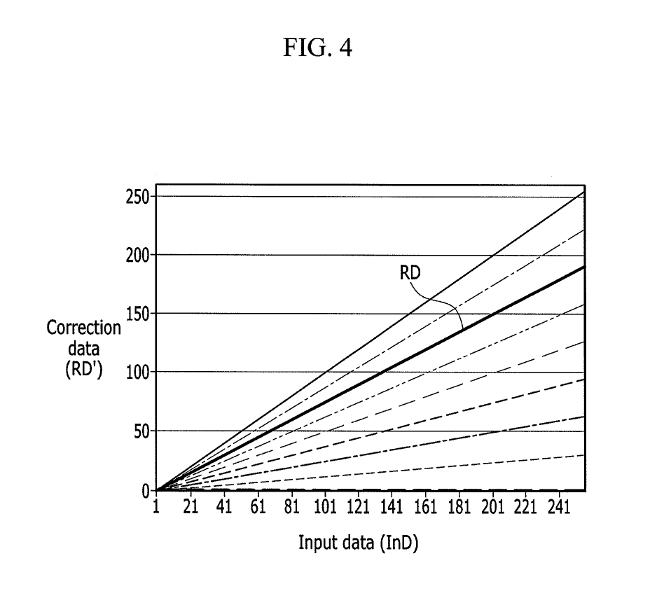

FIG. 4 illustrates a view to explain dimming stages in accordance with an exemplary embodiment. Referring to FIG. 4, grayscale data RD of input data InD is converted into correction data RD′ according to each of a plurality of dimming stages. That is, in accordance with an exemplary embodiment, luminance may be sequentially changed according to each frame sequence of input data InD during display on/off operations, thereby allowing the user to properly view an image.

Moreover, the luminance level of input data InD can be changed without using a frame memory, and the memory size can be reduced by performing gamma correction with a single gamma curve.

By way of summation and review, a first image displayed on the display panel after the initialization process or an image displayed right before switching to power saving mode or standby mode undergoes an abrupt change in luminance. Thus, the image may look unnatural to the user. Accordingly, methods of gradually changing luminance are under development.

In general, methods of gradually changing luminance include a method of determining the setting value of a gamma reference voltage at each stage by using a plurality of gamma curves and a method of gradually adjusting the pulse width of a light-emission control signal that controls the light-emitting time of an organic light emitting diode.

However, the method using a plurality of different gamma curves requires that the optimum setting value of the gamma reference voltage is taken by testing the display panel in advance, and the taken setting value is stored at each stage in a memory. Accordingly, much time is unnecessarily spent on the testing, and the memory size is limited.

Moreover, gradually adjusting the pulse width of a light-emission control signal, it is difficult to finely adjust the pulse width of a light-emission control signal, and a large variable width of the light-emission control signal may affect the lifespan of the display panel.

In contrast, in accordance with embodiments, an organic light emitting display and a driving method thereof control the luminance change rate for each input frame sequence in real time according to dimming data during display on/off operations, without using a plurality of gamma curves or without the need to control a light-emission control signal at each stage. Thus, the luminance of an image during display on/off operations may be smoothly changed, without using a plurality of gamma curves or without the need to control a light-emission control signal at each stage.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display, comprising:
a display region including a plurality of data lines, a plurality of scan lines, and a plurality of pixels connected to corresponding data lines and corresponding scan lines;
a signal controller that converts input data into grayscale data according to gamma control data in a normal mode, changes the gamma control data according to dimming data in a dimming mode to generate gamma correction data, and converts the grayscale data into correction data according to the gamma correction data;
a scan driver that supplies a plurality of scan signals to the plurality of scan lines; and
a data driver that generates a plurality of data signals corresponding to the grayscale data or the correction data, and supplies the plurality of data signals to the plurality of data lines.

2. The organic light emitting display as claimed in claim 1, wherein the dimming data comprises a preset number of dimming stages and a dimming time for each of the dimming stages.

3. The organic light emitting display as claimed in claim 2, wherein the organic light emitting display further comprises a register unit that generates a display-on signal, which is enabled when display-on time for display of an image on the display region is recorded, and a display-off signal, which is enabled when display-off time for non-display of an image on the display region is recorded.

4. The organic light emitting display as claimed in claim 3, wherein the signal controller comprises:
a frame counter that counts a sequence of frames of the input data, in synchronization with the display-on signal or the display-off signal;
a luminance change rate calculator that matches each frame sequence to a corresponding dimming stage according to the dimming data, and calculates the luminance change rate for each frame sequence corresponding to each dimming stage; and
a gamma setting unit that generates the gamma correction data according to the luminance change rate.

5. The organic light emitting display as claimed in claim 4, wherein the luminance change rate calculator calculates a number of frames included in each of the plurality of dimming stages according to one period of a vertical synchronization signal for dividing the input data into a plurality of frames and the dimming time.

6. The organic light emitting display as claimed in claim 2, wherein the dimming time is equal for each of the dimming stages.

7. The organic light emitting display as claimed in claim 2, wherein correction data for the dimming stages have different grayscales.

8. A driving method of an organic light emitting display including a display region including a plurality of data lines, a plurality of scan lines, and a plurality of pixels connected to corresponding data lines and corresponding scan lines, the data lines receiving data signals and the scan lines receiving scan signals, the method comprising:
converting input data into grayscale data according to gamma control data in a normal mode;
in a dimming mode, changing the gamma control data according to dimming data to generate gamma correction data and converting the grayscale data into correction data according to the gamma correction data; and
generating data signals corresponding to the grayscale data or the correction data.

9. The method as claimed in claim 8, further comprising receiving dimming data including a preset number of dimming stages and a dimming time for each of the dimming stages.

10. The method as claimed in claim 9, further comprising:
generating a display-on signal, which is enabled when display-on time for display of an image on the display region is recorded; and
generating a display-off signal, which is enabled when display-off time for non-display of an image on the display region is recorded.

11. The method as claimed in claim 10, wherein generating the gamma correction data comprises:
counting a sequence of frames of the input data, in synchronization with the display-on signal or the display-off signal;
matching each frame sequence to a corresponding dimming stage according to the dimming data;
calculating a luminance change rate for each frame sequence corresponding to each dimming stage; and
changing the gamma correction data according to the luminance change rate.

12. The method as claimed in claim 11, wherein matching of each frame sequence to a corresponding step comprises calculating a number of frames included in each of the plurality of dimming stages according to one period of a vertical synchronization signal for dividing the input data into a plurality of frames and the dimming time.

13. The method as claimed in claim 9, wherein the dimming time is equal for each of the dimming stages.

14. The method as claimed in claim 9, wherein correction data for the dimming stages have different grayscales.
